(19) United States
(12) Patent Application Publication
(10) Pub. No.: US 2013/0061086 A1
(43) Pub. Date: Mar. 7, 2013

(54) FAULT-TOLERANT SYSTEM, SERVER, AND FAULT-TOLERATING METHOD

(71) Applicant: Kiyoshi BABA, Tokyo (JP)

(72) Inventor: Kiyoshi BABA, Tokyo (JP)

(73) Assignee: NEC Corporation, Tokyo (JP)

(21) Appl. No.: 13/414,643

(22) Filed: Mar. 7, 2012

(30) Foreign Application Priority Data
Sep. 3, 2011 (JP) 2011-051983

(51) Int. Cl. G06F 9/455; G06F 11/14

(52) U.S. Cl. 714/3; 718/1; 714/E11.132

(57) ABSTRACT

To provide a fault-tolerant system requiring only one new server when the number of jobs to he processed concurrently exceeds the number of jobs processable by the current servers and requiring no standby servers. Servers 1 and 2 each run a hypervisor to establish multiple virtual machines. The hypervisors assign primary and secondary to the virtual machines in the manner that any of the servers has one or more primary virtual machines and one or more secondary virtual machines, and assign different processing to the virtual machines on the same server. When any of the servers is determined to have failed, the server including the secondary virtual machine paired with the primary virtual machine on the failed server promotes the secondary virtual machine to the primary.

### INCORPORATION BY REFERENCE

This application claims the benefit of Japanese Patent Application No. 2011-51983 filed on Mar. 9, 2011, the entire disclosure of which is incorporated by reference herein.

### TECHNICAL FIELD

This application relates to a fault-tolerant system, server, and fault-tolerating method.

### BACKGROUND ART

Fault-tolerant systems are known for realizing data processing systems that do not shut down and continue to operate even if part of the system fails. Some fault-tolerant systems utilize, for example, a lockstep mode. In a lockstep mode fault-tolerant system, multiplexed system components execute the same processing in sync with each other. For example, a fault-tolerant system executing one job is composed of two servers, in which one serves as the primary and the other serves as the secondary or is on standby.

Under the above circumstances, for example, Unexamined Japanese Patent Application Kokai Publication No. 2009-187090 discloses a cluster system utilizing multiple servers to establish a redundant system for improved system availability. In the cluster system, multiple servers share storage.

Unexamined Japanese Patent Application Kokai Publication No. 2010-026932 discloses a high availability system in which independent virtual computers on a computer are combined for duplication and a primary virtual computer and secondary virtual computer are synchronized in execution while the storage the computers independently possess is maintained in an equal state. In the high availability system, the storages multiple computers possess independently are synchronized.

The server system disclosed in Unexamined Japanese Patent Application Kokai Publication No. 2010-211819 is provided with multiple physical servers on which multiple virtual servers run and a single standby server. The server system utilizes a failure recovery method. When a physical server has failed, the boot disc for virtual mechanisms is reconnected to the standby server and the virtual server that was active at the time of failure is automatically started.

Unexamined Japanese Patent Application Kokai Publication No. 2003-531435 discloses a distributed computer processing system that continues to operate using a shared redundant memory even if either the main server or the backup server becomes unavailable due to failure or the like.

Unexamined Japanese Patent Application Kokai Publication No. 2008-293521 describes a mode for switching a computer connected to the input/output server in a daisy chain connection mode based on instruction from the input/output server. Unexamined Japanese Patent Application Kokai Publication No. H06-131281 describes a network consisting of multiple gates coupled to a network cable to establish both a daisy chain configuration and a bus configuration.

### SUMMARY

The systems described in Unexamined Japanese Patent Application Kokai Publication Nos. 2009-187090 and 2010-026932 have to prepare two new physical servers when the number of jobs to be processed concurrently exceeds the number of jobs processable by two physical servers.

The server system described in Unexamined Japanese Patent Application Kokai Publication No. 2010-211819 requires only one new active server when the number of jobs to be processed concurrently exceeds the number of jobs processable by the active servers. However, the server system requires a standby server and requires a new standby server when the number of jobs to be processed by the standby server exceeds the number of jobs processable by the standby server. Furthermore, since the standby server is instructed to start a virtual server after a physical server has failed, it takes time to switch between the failed physical server and the standby server.

In the distributed computer processing system described in Unexamined Japanese Patent Application Kokai Publication No. 2003-531435, the main server and backup server are fixed. Two new servers have to be prepared when the number of jobs to be processed concurrently exceeds the number of jobs processable by the two servers.

The techniques described in Unexamined Japanese Patent Application Kokai Publication Nos. 2008-293521 and H06-131281 do not constitute a fault-tolerant system.

The present invention is invented in view of the above problems and an exemplary object of the present invention is to provide a fault-tolerant system, server, and fault-tolerating method requiring only one new server when the number of jobs to be processed concurrently exceeds the number of jobs processable by the current servers and requiring no standby servers.

The fault-tolerant system according to a first exemplary aspect of the present invention includes:
two or more servers including two or more virtual machines to each of which different processing is assigned, wherein:
any of the servers has one or more of the virtual machines serving as the primary and one or more of the virtual machines serving as the secondary.

The server according to a second exemplary aspect of the present invention is:
a server including two or more virtual machines to each of which different processing is assigned and connected to one or more other servers, wherein:
the server has one or more of the virtual machines serving as the primary and one or more of the virtual machines serving as the secondary.

The fault-tolerating method according to a third exemplary aspect of the present invention includes the following step to be executed by two or more servers including two or ore virtual machines to each of which different processing is assigned:
an assigning step of assigning primary or secondary to the virtual machines in the manner that any of the servers has one or more of the virtual machines serving as the primary and one or more of the virtual machines serving as the secondary.

The present invention requires only one new server when the number of jobs to be processed concurrently exceeds the number of jobs processable by the current servers and requiring no standby servers.

### BRIEF DESCRIPTION OF THE DRAWINGS

A more complete understanding of this application can be obtained when the following detailed description is considered in conjunction with the following drawings, in which:

FIG. 1 is an illustration showing an exemplary configuration of the fault-tolerant system according to an embodiment of the present invention;

FIG. 2 is an illustration showing an exemplary functional configuration of the server according to the embodiment;

FIG. 3 is a flowchart showing an exemplary operation in the fault-tolerant procedure according to the embodiment;

FIG. 4 is a flowchart showing an exemplary operation in the fault-tolerant procedure according to the embodiment;

FIG. 5 is a diagram of a case in which two servers including two virtual machines process two jobs;

FIG. 6 is a diagram of a case in which three servers including two virtual machines process three jobs;

FIG. 7 is a diagram of a case in which two servers including four virtual machines process four jobs; and

FIG. 8 is a diagram of a case in which three servers including four virtual machines process jobs.

### EXEMPLARY EMBODIMENT

A virtual machine in the present invention means a virtual computer realized on the memory of a server by means of techniques of virtualizing resources such as a computer CPU (central processing unit) and storage server. A primary virtual machine in a fault-tolerant system is a virtual machine primarily executing the processing of a job and a secondary virtual machine is an extra virtual machine to which the same processing is assigned. When the server including the primary virtual machine executing the processing of a job has failed, the secondary virtual machine is promoted to the primary so as to continue the processing of the job.

The fault-tolerant system of the present invention includes multiple servers including two or more virtual machines, any of the servers including one or more primary virtual machines and one or more secondary virtual machines.

Furthermore, in the present invention, the expression “to assign processing” includes not only instructing a virtual machine to execute a job but also setting to copy data on the primary virtual machine so that the secondary virtual machine promoted to the primary can execute the job.

A mode for implementing the present invention will be described in detail hereafter with reference to the drawings. In the drawings, the same or equivalent components are referred to by the same reference numbers.

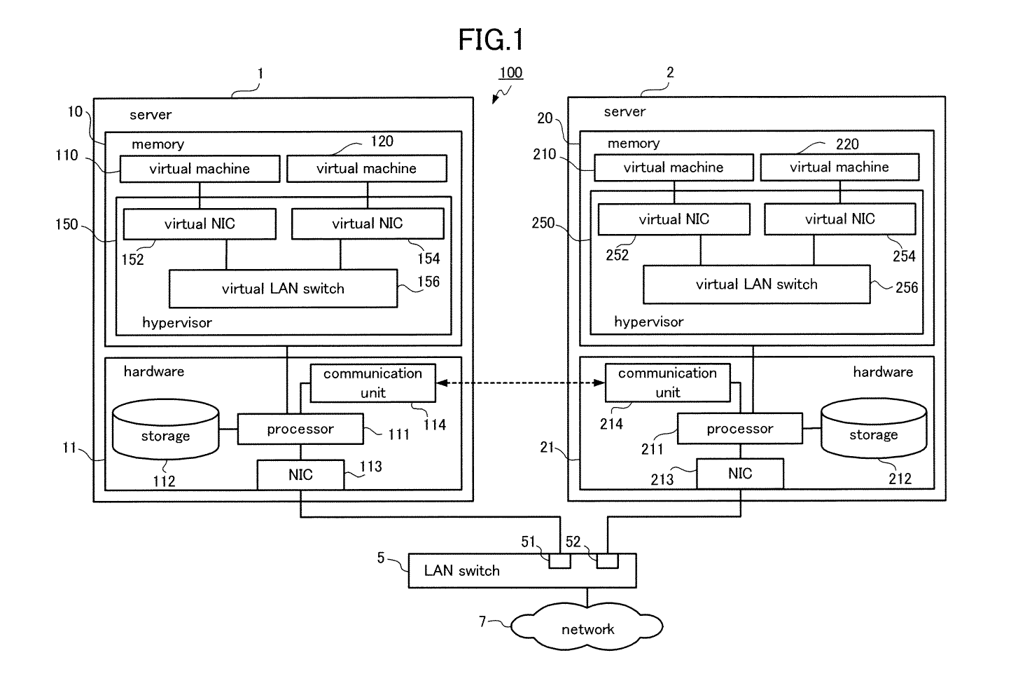

FIG. 1 shows an exemplary configuration of a fault-tolerant system 100 according to an embodiment of the present invention. The fault-tolerant system 100 includes a server 1, a server 2, and a network switch (LAN switch, hereafter) 5.

The LAN switch 5 is connected to a network 7. The LAN switch 5 has a port 51 connected to the server 1 and a port 52 connected to the server 2.

The servers 1 and 2 have the same configuration. Here, the configuration of the server 1 will be described on behalf of them. Hardware 11 includes a storage 112 storing OS (operation system) software of virtual machines 110 and 120 to be established on the server 1, a processor 111 executing various programs stored in the storage 112, a network interface card (NIC, hereafter) for connection to the port 51 of the LAN switch 5, and a communication unit 114. The NIC 113 is a physical interface. The storage 112 can include multiple hard discs. The server 1 realizes the virtual machines by executing the OS software stored in the storage 112. The communication unit 114 communicates with the communication unit 214 of the server 2 via a not-shown interconnect.

A hypervisor 150 and the virtual machines 110 and 120 run on the memory 10. As the server 1 boots, the processor 111 loads and executes startup programs of the hypervisor 150 stored in the storage 12 so that the hypervisor 150 is loaded on the memory 10. With the hypervisor 150 loaded and run on the memory 10, the virtual machines are established. The virtual machines 110 and 120 can run the OS independently. As mentioned above, the OS software of the virtual machines 110 and 120 is stored in the storage 112.

The functional configuration of the hypervisor 150 will be described hereafter. The hypervisor 150 includes a virtual NIC 152 for the virtual machine 110 to conduct LAN communication and a virtual NIC 154 for the virtual machine 120 to conduct LAN communication as virtual interfaces. The hypervisor 150 further includes a virtual LAN switch 156 simulating the LAN switch 5.

The virtual NIC 152 is connected to the NIC 113 via the virtual LAN switch 156 and communicates with the network 7 via the LAN switch 5. Similarly, the virtual NIC 154 is connected to the NIC 113 via the virtual LAN switch 156 and communicates with the network 7 via the LAN switch 5.

Here, the storage 112 stores various data for the virtual machines to execute the processing of jobs including OS software of the virtual machines. The hypervisor 150 may include a virtual storage simulating the storage 112 and allow the virtual machines to exchange data with the virtual storage.

As described above, the hypervisor runs on the processor and the virtual machines running on the hypervisor are realized.

The server 2 includes hardware 21 including a processor 211, a storage 212, an NIC 213, and a communication unit 214, and a memory 20 on which a hypervisor 250 and virtual machines 210 and 220 run, and has the same configuration as the server 1. The hypervisor 250 includes a virtual NIC 252, a virtual NIC 254, and a virtual LAN switch 256. Here, the servers are prepared according to the number of jobs to be processed. Preferably, there are two or more jobs, two or more virtual machines on a server, and two or more servers.

In this embodiment, the hypervisors on the servers 1 and 2 assign processing to the virtual machines in advance, and set them as the primary or as the secondary. Furthermore, the hypervisors share the setting as P/S information. The P/S information is synchronized, for example, via the communication units. Here, different jobs are assigned to the virtual machines on the same server. In other words, the primary and secondary virtual machines for the same job are not present on the same server.

In other words, the server 1 has the secondary virtual machine to which the same processing as to the primary virtual machine on the server 2 is assigned. The server 2 has the secondary virtual machine to which the same processing as to the primary virtual machine on the server 1 is assigned. The hypervisors monitor the resources assigned to the virtual machines. For example, the hypervisors monitor the CPU resources assigned to the virtual machines, resource assignment time, and number of I/O (input/output) operations.

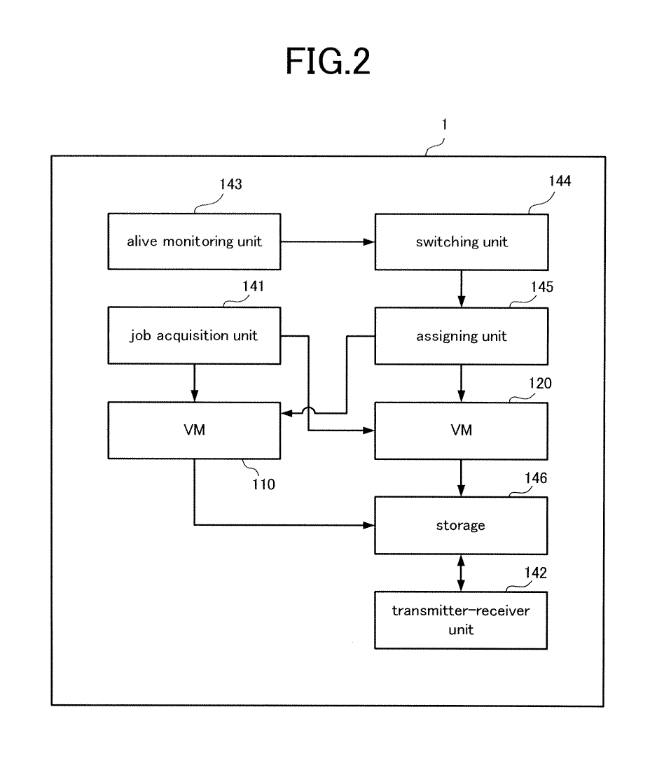

FIG. 2 is an illustration showing an exemplary functional configuration of the server according to the embodiment. The server 1 includes a virtual machine (VM in the figure) 110, a virtual machine (VM in the figure) 120, a job acquisition unit 141, a transmitter-receiver unit 142, an alive monitoring unit 143, a switching unit 144, an assigning unit 145, and a storage 146. The server 2 has the same functional configuration.

The job acquisition unit 141 of the server 1 acquires jobs to be executed by the primary virtual machine. The job acquisition unit 141 is realized by the storage 112, NIC 113, and the hypervisor 150 run by processor 111 on the memory 10.

The virtual machine 110 executes the processing of a job that is assigned to the virtual machine 110 in advance and for which the virtual machine 110 is set as the primary among the jobs acquired by the job acquisition unit 141. The virtual machine 110 stores in the storage 146 result data indicating the results of processing the job. The virtual machine 110 does not execute the processing of a job for which the virtual machine 110 is set as the secondary.

The virtual machine 120 executes the processing of a job that is assigned to the virtual machine 120 in advance and for which the virtual machine 120 is set as the primary among the jobs acquired by the job acquisition unit 141. The virtual machine 120 stores in the storage 146 result data indicating the results of processing the job. The virtual machine 120 does not execute the processing of a job for which the virtual machine 120 is set as the secondary.

The transmitter-receiver unit 142 refers to the P/S information and periodically transmits a copy of data on the primary virtual machine including the result data stored in the storage 146 to the server including the paired secondary virtual machine. Paired virtual machines are virtual machines to which the same processing is assigned. On the other hand, the transmitter-receiver unit 142 receives a copy of data on the primary virtual machine including the result data from the server including the primary virtual machine paired with the secondary virtual machine, and stores the copy in the storage 146. The transmitter-receiver unit 142 is realized by the NIC 113 and the hypervisor 150 run by processor 111 on the memory 10.

Here, the transmitter-receiver unit 142 can transmit or receive a copy of data on the primary virtual machine via interconnect. In other words, the transmitter-receiver unit 142 can be realized by the communication unit 114 and the hypervisor 150 run by processor 111 on the memory 10. Furthermore, a copy of data on the primary virtual machine that is transmitted or received by the transmitter-receiver unit 142 can be a copy of difference from the previous and earlier data.

The alive monitoring unit 143 monitors the other servers as to whether they are alive by means of the communication unit 114. The alive monitoring unit 143 assumes that the server 2 has failed when it has lost communication with the communication unit 214 of the server 2. The alive monitoring unit 143 is realized by the communication unit 114 and the hypervisor 150 run by processor 111 on the memory 10.

The switching it 144 refers to the P/S information and determines whether the server 1 has the secondary virtual machine for the job executed by, as the primary, the virtual machine on the server that is assumed to have failed by the alive monitoring unit 143. For example, if the virtual machine 120 is the secondary virtual machine for the job, the switching unit 144 changes the setting of the virtual machine 120 for the job from the secondary to the primary. Along with the change, the switching unit 144 changes the setting of the virtual machine 120 for the job in the P/S information from the secondary to the primary. Consequently, the virtual machine 120 starts to execute the processing of the job. The switching unit 144 is realized by the hypervisor 150 run by the processor 111 on the memory 10.

The assigning unit 145 communicates with the server 2 in advance and sets the virtual machines as the primary or as the secondary so that the servers 1 and 2 each have one or more primary virtual machines and one or more secondary virtual machines. For example, it is assumed that the assigning unit 145 of the server 1 sets the virtual machine 110 as the primary and the assigning unit 145 of the server 2 sets the virtual machine 210 as the paired secondary virtual machine. In such a case, the assigning unit 145 of the server 1 sets the virtual machine 120 as the secondary and the assigning unit 145 of the server 2 sets the virtual machine 220 as the paired primary. Furthermore, the assigning unit 145 assigns the processing of the same job to the primary virtual machine and secondary virtual machine. The assigning unit 145 writes such setting information in the P/S information. The assigning unit 145 is realized by the hypervisor 150 run by the processor 111 on the memory 10.

The storage 146 stores data on the primary virtual machine including result data indicating the results of processing the job executed by the primary virtual machine. Furthermore, the storage 146 stores a copy of data on the primary virtual machine paired with the secondary virtual machine. The storage 146 is realized by the storage 112.

The setting of virtual machines as the primary or as the secondary will be described in detail hereafter with reference to FIG. 1. The hypervisor 150 assigns, for example, a job A acquired from the network 7 via the LAN switch 5 to the virtual machine 110, and sets the virtual machine 110 as the primary virtual machine for the job A. Then, information indicating that “the virtual machine 110” is set as “the primary” for “the job A” is stored in the P/S information. The hypervisor 250 on the server 2 sets the virtual machine 210 as the secondary virtual machine for the job. Then, information indicating that “the virtual machine 210” is set as “the secondary” for “the job A” is stored in the P/S information. The primary virtual machine 110 for the job A executes the job A and the secondary virtual machine 210 for the job A is on standby.

On the LAN switch 5, the port connected to the server 1 on which the primary virtual machine for the job A is present (the primary port, hereafter) conducts normal communication, transmitting data of the job A to the server 1. The port connected to the server 2 on which the secondary virtual machine for the job A is present (the secondary port, hereafter) does not transmit data of the job A.

Since the virtual machine 110 is the primary and the virtual machine 210 is the secondary, the primary and secondary ports of the LAN switch 5 are the port 51 and port 52, respectively. For example, the LAN switch 5 receives data of the job A from the network 7 and transmits the data of the job A to the NIC 113 of the server 1 through the port 51. Here, no data are transmitted to the NIC 213 of the server 2 through the port 52.

The NIC 113 transfers all received job A data to the virtual LAN switch 156 of the hypervisor 150 run by the processor 111 on the memory 10.

Since the hypervisor 150 has assigned the job A to the virtual machine 110, the virtual LAN switch 156 transfers the received job A data to the virtual NIC 152 of the virtual machine 110.

The virtual machine 110 executes the processing on the received job A data. The virtual machine 110 transfers results data indicating the results of processing the job A data to the virtual LAN switch 156 through the virtual NIC 152.

The virtual LAN switch 156 transfers the data received from the virtual NIC 152 to the storage 112.

The hypervisor 150 periodically transfers a copy of data on the virtual machine 110 stored in the storage 112 to the LAN switch 5 via the NIC 113. The LAN switch 5 transfers the copy of data on the virtual machine 110 received from the NIC 113 to the NIC 213.

The NIC 213 transfers the received copy of data on the virtual machine 110 to the virtual LAN switch 256 of the hypervisor 250 run by the processor 211 on the memory 20. The virtual LAN switch 256 transfers the received copy of data on the virtual machine 110 to the storage 212.

As described above, a copy of data on the primary virtual machine 110 is periodically transferred to the storage 212 of the server 2 including the secondary virtual machine 210. In this way, the virtual machine 110 on the server 1 serves as the primary and the virtual machine 210 on the server 2 serves as the secondary for the job A.

Operation to promote a virtual machine from the secondary to the primary and operation to demote a virtual machine from the primary to the secondary will he described in detail hereafter. For example, when the server 1 has failed, the alive monitoring unit 243 of the server 2 assumes that the server 1 has failed on the basis of lost communication with the communication unit 114 of the server 1. The server 2 has the secondary virtual machine 210 for the job A executed by the virtual machine 110 on the server 1 as the primary. Therefore, the switching unit 144 of the server 2 changes the setting of the virtual machine 210 for the job A from the secondary to the primary and changes the setting of the virtual machine 210 in the P/S information from the secondary to the primary. Consequently, the virtual machine 210 starts to execute the processing of the job A and stores result data indicating the results of processing the job A in the storage 146.

For example, the following procedure is executed for promoting the virtual machine 210 from the secondary to the primary for the job A. The following explanation will be made with reference to FIG. 1.

Before the server 1 has failed, the port 51 of the LAN switch 5 conducts normal communication, transmitting job A data to the server 1, and the port 52 does not transmit the job A data to the server 2. The LAN switch 5 transfers data based on an FDB (forwarding database) which learns and stores the MAC address in the received data. Therefore, the hypervisor 250 issues a dummy ARP (address resolution protocol) and changes the FDB to designate the destination of the job A data to the port 52. After the FDB is changed, the LAN switch 5 transmits the job A data to the server 2 through the port 52 and does not transmit the job A data to the server 1 through the port 51.

The NIC 213 transfers all received job A data to the virtual LAN switch 256 of the hypervisor 250 run by the processor 211 on the memory 20.

The virtual LAN switch 256 transfers the received data to the virtual NIC. Since the virtual machine 210 is assigned to the primary for the job A, the virtual LAN switch 156 transfers the job A data to the virtual NIC 252 of the virtual machine 210.

The virtual machine 210 executes the processing the received job A data. The virtual machine 210 transfers result data indicating the results of processing the job A data to the virtual LAN switch 256 through the virtual NIC 252.

The virtual LAN switch 256 transfers the data received from the virtual NIC 252 to the storage 212.

Then, the virtual machine 210 has been promoted to the primary.

Then, after the server 1 is recovered, the switching unit 144 of the server 1 changes the setting of the virtual machine 110 for the job A from the primary to the secondary and changes the setting of the virtual machine 110 for the job A in the P/S information from the primary to the secondary. As the server 1 is recovered, the alive monitoring unit 143 of the server 2 assumes that the server 1 is recovered on the basis of resumed communication with the communication unit 114 of the server 1. The transmitter-receiver unit 142 of the server 2 periodically transmits a copy of data on the virtual machine 210 including result data indicating the results of processing the job A executed by the virtual machine 210 to the server 1 including the secondary virtual machine 110 paired with the virtual machine 210.

For example, the following procedure is executed for demoting the virtual machine 110 from the primary to the secondary for the job A. The following explanation will be made with reference to FIG. 1.

After the server 1 is recovered, the communication unit 114 resumes communication with the communication unit 214. After communication between the communication units 114 and 214 is resumed, the hypervisor 250 on the server 2 periodically transfers a copy of data on the virtual machine 210 stored in the storage 212 to the LAN switch 5 via the NIC 213. The LAN switch 5 transfers the copy of data on the virtual machine 210 received from the NIC 213 to the NIC 113.

The NIC 113 transfers the received copy of data on the virtual machine 210 to the virtual LAN switch 156 of the hypervisor 150 run by the processor 111 on the memory 10. The virtual LAN switch 156 transfers the received copy of data on the virtual machine 210 to the storage 112.

Then, the virtual machine 110 has been demoted to the secondary.

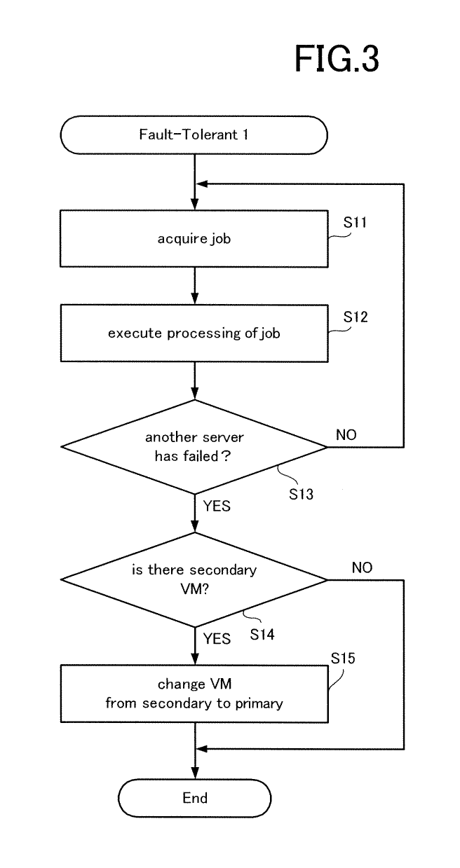

FIG. 3 is a flowchart showing an exemplary operation in the fault-tolerant procedure according to the embodiment. FIG. 3 shows an exemplary operation executed by a server when a failure on another server is detected. The assigning units 145 of the servers communicate with one or more other servers in advance to assign jobs to the virtual machines and set the virtual machines as the primary or as the secondary in the manner that any of the servers has one or more primary virtual machines and one or more secondary virtual machines. Furthermore, the assigning units 145 of the servers assign the same processing to a pair of virtual machines having the primary/secondary relationship. The job acquisition unit 141 acquires a job from the network 7 or storage 112 or a virtual storage (Step S11). A virtual machine assigned to the processing of the job and set as the primary executes the processing of the job acquired by the job acquisition unit 141 (Step S12).

The alive monitoring unit 143 determines whether other servers have failed on the basis of communication with the other servers. If the alive monitoring unit 143 determines that no server has failed (Step S13; NO), return to Step S11 and repeat the Steps S11 to S13. If the alive monitoring unit 143 determines that another server has failed on the basis of lost communication with the server (Step S13; YES), the switching unit 144 determines whether there is the secondary virtual machine (VM in the figure) for the job executed by the primary virtual machine on the server having failed (Step S14).

If there is the secondary virtual machine for the job (Step S14: YES), the setting of the virtual machine is changed from the secondary to the primary (Step S15), and the procedure ends. If there is no secondary virtual machine for the job (Step S14; NO), the procedure ends without conducting the changing in the Step S15.

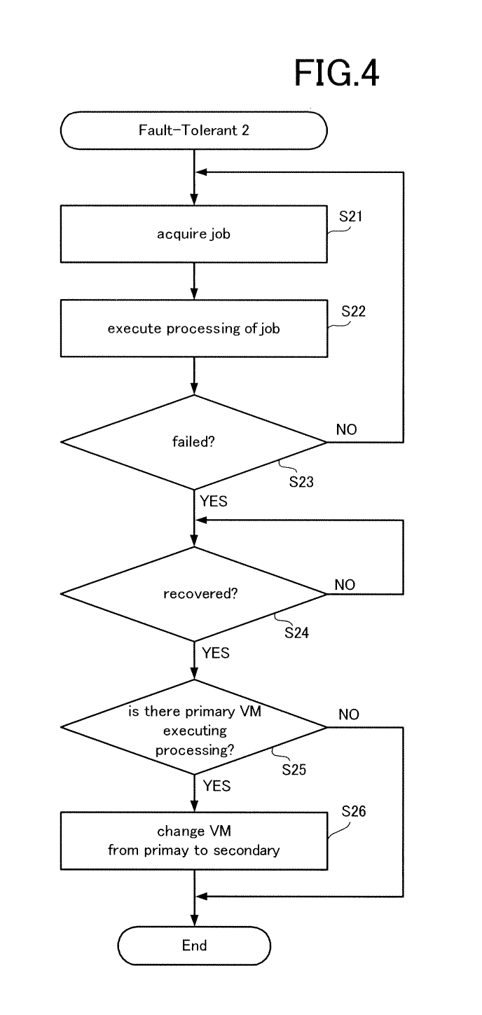

FIG. 4 is a flowchart showing an exemplary operation in the fault-tolerant procedure according to the embodiment. FIG. 4 shows an exemplary operation executed by a server when the server has failed. The assigning units 145 of the servers communicate with one or more other servers in advance to assign jobs to the virtual machines and set the virtual machines as the primary or as the secondary in the manner that, any of the servers has one or more primary virtual machines and one or more secondary virtual machines. The job acquisition unit 141 acquires a job from the network 7 or storage 112 or a virtual storage (Step S21). The virtual machine assigned to the processing of the job and set as the primary executes the processing of the job acquired by the job acquisition unit 141 (Step S22).

If the server has no failure (Step S23; NO), flow returns to the Step S21 and repeats the Steps S21 to S23. On the other hand, if the server has failed (Step S23; YES), it checks if it has been recovered (Step S24). If the server has not been recovered (Step S24; NO), repeats the Step S24. If the server has been recovered (Step S24; YES), the server checks if it has a virtual machine (VM in the figure) executing processing as the primary (Step S25). If the server has a virtual machine executing processing as the primary (Step S25; Yes), the setting of the virtual machine is changed from the primary to the secondary (Step S26), and the procedure ends. If the server has no virtual machine executing processing as the primary (Step S25; NO), the procedure ends without conducting the changing in the Step S26.

In the above, the processing of the job A is executed by a pair of virtual machines, the virtual machine 110 on the server 1 and the virtual machine 210 on the server 2. Execution of processing of multiple jobs by three or more servers comprising two virtual machines will be described hereafter.

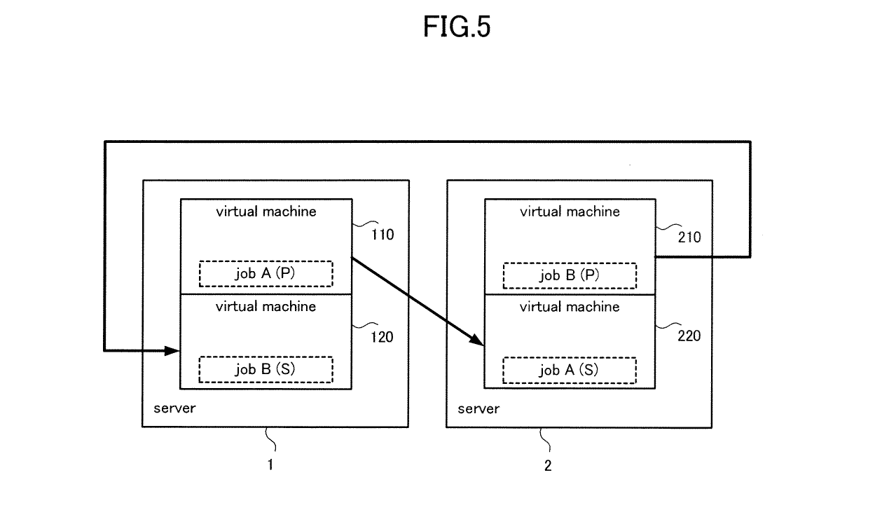

FIG. 5 is a diagram of a case in which two servers including two virtual machines process two jobs. In the example of FIG. 5, servers 1 and 2 each including two virtual machines process two jobs A and B. The arrows in the figure each originate from a primary virtual machine and end at a secondary virtual machine. As for characters in parentheses after the job names, P indicates Primary and S indicates Secondary. This applies to explanation below in regard to the other figures.

The server 1 includes a virtual machine 110 and a virtual machine 120. The server 2 includes a virtual machine 210 and a virtual machine 220.

The assigning unit 145 of the server 1 assigns the processing of the job A to the virtual machine 110 and designates the virtual machine 110 to the primary virtual machine for the job A. Furthermore, the assigning unit 145 of the server 1 assigns the processing of the job B to the virtual machine 120 and designates the virtual machine 120 to the secondary virtual machine for the job B. The assigning unit 145 of the server 2 assigns the processing of the job B to the virtual machine 210 and designates the virtual machine 210 to the primary virtual machine for the job B. Furthermore, the assigning unit 145 of the server 2 assigns the processing of the job A to the virtual machine 220 and designates the virtual machine 220 to the secondary virtual machine for the job A.

Consequently, even if the server 1 has failed, the virtual machine 220 on the server 2 is promoted to the primary for the job A to continue the processing. On the other hand, even if the server 2 has failed, the virtual machine 120 on the server 1 is promoted to the primary for the job B to continue the processing.

In the event that a third job C is added in the situation of FIG. 5, a server 3 will be added.

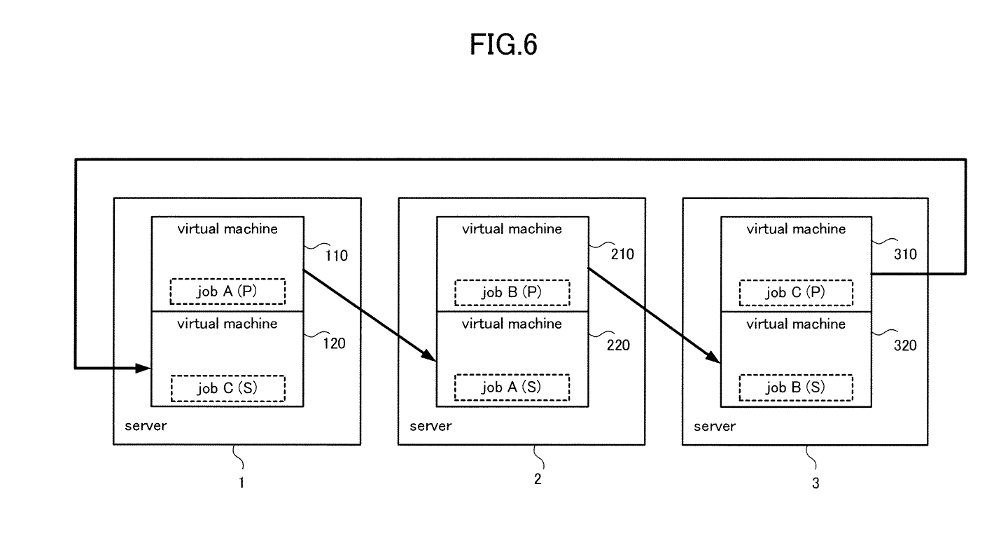

FIG. 6 is a diagram of a case in which three servers including two virtual machines process three jobs. In the example of FIG. 6, servers 1, 2, and 3 each including two virtual machines process jobs A, B, and C.

The server 3 includes a virtual machine 310 and a virtual machine 320. The assigning unit 145 of the server 3 assigns the processing of the job C to the virtual machine 310 and designates the virtual machine 310 to the primary virtual machine for the job C. Furthermore, the assigning unit 145 of the server 3 assigns the processing of a job B to the virtual machine 320 and designates the virtual machine 320 to the secondary virtual machine for the job B. Here, the assigning unit 145 of the server 1 assigns the processing of the job C to the virtual machine 120, to which the processing of the job B was assigned, and designates the virtual machine 120 to the secondary virtual machine for the job C.

As described above, in the fault-tolerant system 100 of this embodiment, when one server has two virtual machines, the servers can be added one by one in the event that the number of jobs exceeds the number of jobs processable by the current servers. Furthermore, an added server has no idle virtual machine, preferably wasting nothing.

However, the present invention does not limit the number of virtual machines on one server to two. A case in which two or more servers comprising four virtual machines execute processing of multiple jobs will be described hereafter.

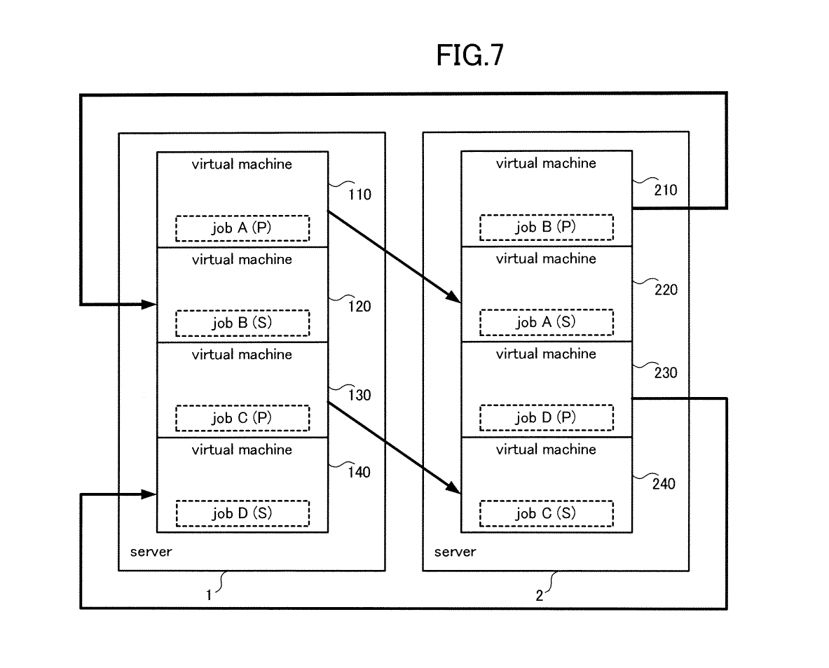

FIG. 7 is a diagram of a case in which two servers including four virtual machines process four jobs. In the example of FIG. 7, servers 1 and 2 each including four virtual machines process four jobs A, B, C, and D.

The server 1 includes virtual machines 110, 120, 130, and 140. The server 2 includes virtual machines 210, 220, 230, and 240.

The assigning unit 145 of the server 1 assigns the processing of the job A to the virtual machine 110 and designates the virtual machine 110 to the primary virtual machine for the job A, and assigns the processing of the job B to the virtual machine 120 and designates the virtual machine 120 to the secondary virtual machine for the job B. Furthermore, the assigning unit 145 of the server 1 assigns the processing of the job C to the virtual machine 130 and designates the virtual machine 130 to the primary virtual machine for the job C, and assigns the processing of the job D to the virtual machine 140 and designates the virtual machine 140 to the secondary virtual machine for the job D.

The assigning unit 145 of the server 2 assigns the processing of the job B to the virtual machine 210 and designates the virtual machine 210 to the primary virtual machine for the job B, and assigns the processing of the job A to the virtual machine 220 and designates the virtual machine 220 to the secondary virtual machine for the job A. Furthermore, the assigning unit 145 of the server 2 assigns the processing of the job D to the virtual machine 230 and designates the virtual machine 230 to the primary virtual machine for the job D, and assigns the processing of the job C to the virtual machine 240 and designates the virtual machine 240 to the secondary virtual machine for the job C.

Consequently. even if the server 1 has failed, the virtual machines 220 and 240 on the server 2 are promoted to the primary to continue the processing of the jobs A and C. On the other hand, even if the server 2 has failed, the virtual machines 120 and 140 on the server 1 are promoted to the primary to continue the processing of the jobs B and D.

In the event that a fifth job E is added in the situation of FIG. 7, a server 3 will be added.

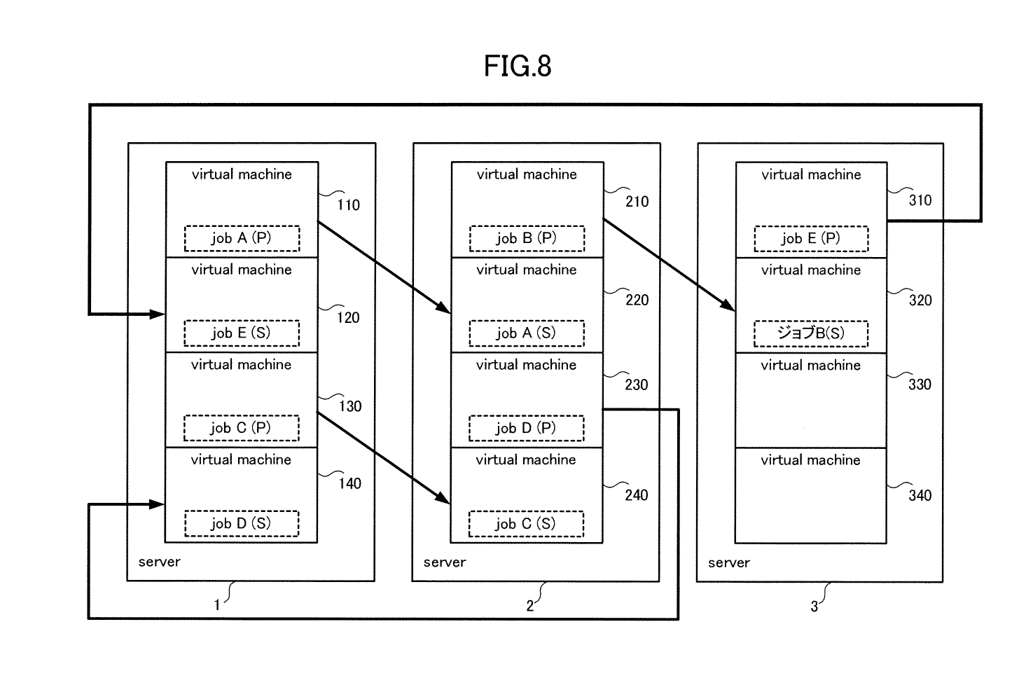

FIG. 8 is a diagram of a case in which three servers including four virtual machines process five jobs. In the example of FIG. 8, servers 1, 2, and 3 each including four virtual machines process jobs A, B, C, D, and E.

The server 3 includes virtual machines 310, 320, 330, and 340. The assigning unit 145 of the server 3 assigns the job E to the virtual machine 310 and designates the virtual machine 310 to the primary virtual machine for the job E. Furthermore, the assigning unit 145 of the server 3 assigns the job B to the virtual machine 320 and designates the virtual machine 320 to the secondary virtual machine for the job B. Here, the assigning unit 145 of the server 1 assigns the job E to the virtual machine 120, to which the processing of the job B was assigned, and designates the virtual machine 120 to the secondary virtual machine for the job E. When more jobs are added, the processing of jobs is assigned to the idle virtual machines 330 and 340.

As described above, even when one server has four virtual machines, the servers can be added one by one in the event that the number of jobs exceeds the number of jobs processable by the current servers. When one server has four virtual machines and the number of jobs exceeds the number of jobs processable by the current servers by one, a newly added server will have two idle virtual machines. However, the number of servers is smaller than in the case in which one server has two virtual machines for the same number of jobs. Therefore, reduced cost can be expected. The same applies to the case in which one server has three virtual machines.

In FIG. 6 or FIG. 8, three or more servers are connected in a daisy chain mode and sequenced. The primary/secondary is assigned in the manner that the server subsequent to a given server has the secondary virtual machine paired with the primary virtual machine on the given server, and the first server has the secondary virtual machine paired with the primary virtual machine on the last server. With this structure, if the number of jobs exceeds the number of jobs processable by the current servers by one, only one virtual machine is subject to change in job assignment among the virtual machines on the existing servers. Here, the expression “the servers are sequenced” indicates the sequence of two or more servers in regard to their primary/secondary relationship. Other server operations do not need to follow this sequence.

When three or more servers are connected, it is preferable that the primary/secondary is assigned in the manner that the virtual machines on a server have the primary/secondary relationship with virtual machines on at least two other servers.

In this embodiment, a memory copy mode fault-tolerant system is described in which data on the primary virtual machine is copied in the storage of the server including the secondary virtual machine. However, the present invention is not confined thereto. For example, an external storage can be provided so that the server including the primary virtual machine and the server including the secondary virtual machine share data on the primary virtual machine. Furthermore, in this embodiment, the secondary virtual machine does not execute the processing of an assigned job. However, the present invention is not confined thereto. A lockstep mode in which the primary and secondary virtual machines process the same job in parallel can be employed.

Furthermore, in this embodiment, a server has two virtual machines or four virtual machines. However, the present invention is not confined thereto. A server can have two or more virtual machines, and even an odd number of virtual machines. For example, if a server has an odd number of virtual machines and there are an odd number of servers, at least one virtual machine is idle in any case. However, even in such a case, when the number of jobs exceeds the number of jobs processable by the current servers by one, only one virtual machine is subject to change in job assignment among the virtual machines on the existing servers.

The above-described embodiment can partly or entirely be described as in the following supplementary notes, but not restricted thereto.

(Supplementary Note 1)

A fault-tolerant system, including two or more servers including two or more virtual machines to each of which different processing is assigned, wherein:
any of the servers has one or more of the virtual machines serving as the primary and one or more of the virtual machines serving as the secondary.

(Supplementary Note 2)

The fault-tolerant system according to Supplementary Note 1, wherein:
the servers are sequenced;
among the servers, the server subsequent to a given server has the secondary virtual machine to which the same processing as to the primary virtual machine on the given server is assigned; and
among the servers, the first server has the secondary virtual machine to which the same processing as to the primary virtual machine on the last server is assigned.

(Supplementary Note 3)

The fault-tolerant system according to Supplementary Note 1 or 2, wherein:
the primary or secondary virtual machines to which the same processing as to the virtual machines on any one of the servers is assigned are present on two or more other servers.

(Supplementary Note 4)

The fault-tolerant system according to any of Supplementary Notes 1 to 3, wherein:
the servers include an assignor assigning the primary or secondary to the virtual machines in the manner that any of the servers has one or more of the primary virtual machines and one or more of the secondary virtual machines.

(Supplementary Note 5)

The fault-tolerant system according to any of Supplementary Notes 1 to 4, wherein:
the servers have two of the virtual machines.

(Supplementary Note 6)

The fault-tolerant system according to any of Supplementary Notes 1 to 5, wherein the servers include:
a job acquirer acquiring jobs of which the processing is executed by the virtual machines;
an alive monitor communicating with the other servers and determining whether any of the other servers has failed; and
a switcher changing the secondary virtual machine to the primary virtual machine for a job processed by the primary virtual machine on the server as to which the alive monitor has determined to have failed when there is the secondary virtual machine for the job.

(Supplementary Note 7)

The fault-tolerant system according to Supplementary Note 6, wherein:
when the server as to which the alive monitor has determined to have failed is recovered, the switcher of the failed server changes the primary virtual machine to the secondary virtual machine.

(Supplementary Note 8)

The fault-tolerant system according to any of Supplementary Notes 1 to 7, wherein:
the two or more servers include internal storages storing data for the primary virtual machines to execute the processing, and copy the data on the primary virtual machine to the storage of the server including the secondary virtual machine.

(Supplementary Note 9)

The fault-tolerant system according to any of Supplementary Notes 1 to 8, wherein:
the two or more servers include external storages storing data for the virtual machines to execute the processing, and share the storage.

(Supplementary Note 10)

A server including two or more virtual machines to each of which different processing is assigned and connected to one or more other servers, wherein:
the server has one or more of the virtual machines serving as the primary and one or more of the virtual machines serving as the secondary.

(Supplementary Note 11)

A fault-tolerating method, including the following step to be executed by two or more servers including two or more virtual machines to each of which different processing is assigned:
an assigning step of assigning primary or secondary to the virtual machines in the manner that any of the servers has one or more of the virtual machines serving as the primary and one or more of the virtual machines serving as the secondary.

(Supplementary Note 12)

The fault-tolerating method according to Supplementary Note 11, further including the following steps to be executed by the servers:
a job acquisition step of acquiring jobs which the processing is executed by the virtual machines;
an alive monitoring step of communicating with the other servers and determining whether any of the other servers has failed; and
a switching step of changing the secondary virtual machine to the primary virtual machine for a job processed by the primary virtual machine on the server which has been determined to have failed in the alive monitoring step when there is the secondary virtual machine for the job.

(Supplementary Note 13)

The fault-tolerating method according to Supplementary Note 12, wherein:
when the server which has been determined to have failed in the alive monitoring step is recovered, the primary virtual machine is changed to the secondary virtual machine in the switching step on the failed server.

(Supplementary Note 14)

A computer-readable recording medium storing programs allowing a computer connected to one or more other computers to function as:
two or more virtual machines to each of which different processing is assigned; and
an assignor assigning primary or secondary to the virtual machines in the manner that any of the computers has one or more the virtual machines serving as the primary and one or more the virtual machines serving as the secondary.

### INDUSTRIAL APPLICABILITY

The present invention is applicable to a fault-tolerant system requiring only one new server when the number of jobs to be processed concurrently exceeds the number jobs processable by the current servers and requiring no standby servers.

Having described and illustrated the principles of this application by reference to one preferred embodiment, it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

What s claimed is:

1. A fault-tolerant system, comprising two or more servers including two or ore virtual machines to each of which different processing is assigned, wherein:
any of the servers has one or more of the virtual machines serving as the primary and one or more of the virtual machines serving as the secondary.

2. The fault-tolerant system according to claim 1, wherein:
the servers are sequenced;
among the servers, the server subsequent to a given server has the secondary virtual machine to which the same processing as to the primary virtual machine on the given server is assigned; and
among the servers, the first server has the secondary virtual machine to which the same processing as to the primary virtual machine on the last server is assigned.

3. The fault-tolerant system according to claim 1, wherein:
the primary or secondary virtual machines to which the same processing as to the virtual machines on any one of the servers is assigned are present on two or more other servers.

4. The fault-tolerant system according to claim 2, wherein:
the primary or secondary virtual machines to which the same processing as to the virtual machines on any one of the servers is assigned are present on two or more other servers.

5. The fault-tolerant system according to claim 1, wherein:
the servers include an assignor assigning the primary or secondary to the virtual machines in the manner that any of the servers has one or more of the primary virtual machines and one or more of the secondary virtual machines.

6. The fault-tolerant system according to claim 2, wherein:
the servers include an assignor assigning the primary or secondary to the virtual machines in the manner that any of the servers has one or more of the primary virtual machines and one or more of the secondary virtual machines.

7. The fault-tolerant system according to claim 1, wherein:
the servers have two of the virtual machines.

8. The fault-tolerant system according to claim 2, wherein:
the servers have two of the virtual machines.

9. The fault-tolerant system according to claim 1, wherein the servers comprise:
a job acquirer acquiring jobs of which the processing is executed by the virtual machines;
an alive monitor communicating with the other servers and determining whether any of the other servers has failed; and
a switcher changing the secondary virtual machine to the primary virtual machine for a job processed by the primary virtual machine on the server as to which the alive monitor has determined to have failed when there is the secondary virtual machine for the job.

10. The fault-tolerant system according to claim 2, wherein the servers comprise:
a job acquirer acquiring jobs of which the processing is executed by the virtual machines;
an alive monitor communicating with the other servers and determining whether any of the other servers has failed; and
a switcher changing the secondary virtual machine to the primary virtual machine for a job processed by the primary virtual machine on the server as to which the alive monitor has determined to have failed when there is the secondary virtual machine for the job.

11. The fault-tolerant system according to claim 9, wherein:
when the server as to which the alive monitor has determined to have failed is recovered, the switcher of the failed server changes the primary virtual machine to the secondary virtual machine.

12. The fault-tolerant system according to claim 10, wherein:
when the server as to which the alive monitor has determined to have failed is recovered, the switcher of the failed server changes the primary virtual machine to the secondary virtual machine.

13. The fault-tolerant system according to claim 1, wherein:
the two or more servers comprise internal storages storing data for the primary virtual machines to execute the processing, and copy the data on the primary virtual machine to the storage of the server including the secondary virtual machine.

14. The fault-tolerant system according to claim 2, wherein:
the two or more servers comprise internal storages storing data for the primary virtual machines to execute the processing, and copy the data on the primary virtual machine to the storage of the server including the secondary virtual machine.

15. The fault-tolerant system according to claim 1, wherein:
the two or more servers comprise external storages storing data for the virtual machines to execute the processing, and share the storage.

16. The fault-tolerant system according to claim 2, wherein:
the two or more servers comprise external storages storing data for the virtual machines to execute the processing, and share the storage.

17. A server including two or more virtual machines to each of which different processing is assigned and connected to one or more other servers, wherein:
the server has one or more of the virtual machines serving as the primary and one or more of the virtual machines serving as the secondary.

18. A fault-tolerating method, comprising the following step to be executed by two or more servers including two or more virtual machines to each of which different processing is assigned:
an assigning step of assigning primary or secondary to the virtual machines in the manner that any of the servers has one or more of the virtual machines serving as the primary and one or more of the virtual machines serving as the secondary.

19. The fault-tolerating method according to claim 18, further comprising the following steps to be executed by the servers:
a job acquisition step of acquiring jobs of which the processing is executed by the virtual machines;
an alive monitoring step of communicating with the other servers and determining whether any of the other servers has failed; and
a switching step of changing the secondary virtual machine to the primary virtual machine for a job processed by the primary virtual machine on the server which has been determined to have failed in the alive monitoring step when there is the secondary virtual machine for the job.

20. The fault-tolerating method according to claim 19, wherein:
when the server which has been determined to have failed in the alive monitoring step is recovered, the primary virtual machine is changed to the secondary virtual machine in the switching step on the failed server.
